(19) United States
(12) Patent Application Publication
(10) Pub. No.: US 2025/0309335 A1
(43) Pub. Date: Oct. 2, 2025

(54) Solid-State Aluminum-Ion Battery with Carbonized Luffa Cathode

(71) Applicant: Olurinde Ebenezer Lafe, Bentleyville, OH (US)

(72) Inventor: Olurinde Ebenezer Lafe, Bentleyville, OH (US)

(73) Assignee: Fuel Cells Global LTD, Bentleyville, OH (US)

(21) Appl. No.: 18/622,873

(22) Filed: Mar. 30, 2024

(51) Int. Cl. H01M 10/054; H01M 4/46; H01M 10/0562

(52) U.S. Cl. CPC H01M 10/054; H01M 4/463; H01M 10/0562

(57) ABSTRACT

A method and apparatus for storing electricity using a rechargeable, membrane-free, electrochemical cell with axially placed coiled aluminum wire anode, carbonized luffa sponge cathode, and a solid electrolyte. The invention teaches the use of common ultra-low-cost material components, and a simple cell construction method.

### REFERENCES

Archer, L., Das, S. & Navaneedhakrishman, 2014. Aluminum Ion Battery Including Metal Sulfide or Monocrystalline Vanadium Oxide Cathode and Ionic Liquid Based Electrolyte. United States of America, Patent No. 20140242457.

Azimi, G. & Ng, K. L., 2023. Aluminum-Ion Battery Using Aluminum Chloride/Trimethylamine Ionic Liquid As Electrolyte. United States of America, Patent No. 20230104025.

Bockstie, L., Trevethan, D. & Zaromb, S., 1963. Control of Al corrosion in caustic solutions. Journal of The Electrochemical Society, 110(4), pp. 267-271.

Caban-Acevado, M. & Yushin, G., 2023. Rechargeable Batteries With Alkali Metal Ion Cathodes, Aluminum Metal-Based Anodes And Displacement Electrolyte. United States of America, Patent No. 20230411595.

Craig, B., Schoetz, T., Cruden, A. & Ponce de Leon, C., 2020. Review of current progress in non-aqueous aluminum batteries. Renewable and Sustainable Energy Reviews, Volume 133.

Cui, Y. et al., 2018. Developing porous carbon with dihydrogen phosphate groups as sulfur host for high performance lithium sulfur batteries. Journal of Power Sources, Volume 378, pp. 40-47.

Das, S. K., Mahapatra, S. & Lahan, H., 2017. Alumnum-ion batteries: developments and challenges. J. Mater. Chem. A, Volume 5, pp. 6347-6367.

Du Yuan, Jin Zhao, William Manalastas Jr., Sonal Kumar, Madhavi Srinivasan, 2020. Emerging rechageable aqueous aluminum ion battery: Status, challenges, and outlooks. Nano Materials Science, pp. 248-263.

Elia, G. et al., 2021. An Overview and Prospective on AI and Al-Ion Battery Technologies. Journal of Power Sources, 481(228870).

Friesen, C. A. & Martinez, J. A. B., 2018. s.l. U.S. Pat. No. 10,090,520.

Friesen, C. A., McDowell, F. & Bautista, M. J. A., 2016. Aluminum-Based Metal-Air Batteries. United States of America, U.S. Pat. No. 9,236,643 B2.

Gan, F. et al., 2019. Low cost ionic liquid electrolytes for rechargeable aluminum/graphite batteries. International Journal of Ionics-The Science and Technology of Ionic Motion, Volume 25, pp. 4243-4249.

Gao, C. & Chen, H., 2018. Preparation Method of Graphene Film Anode Material and Application in Aluminum Ion Battery. United States of America, Patent No. 20190296353.

Giuseppe, Antonio Elia, Kostiantyn V. Kravchyk, Maksym V. Kovalenko, Joaquin Chacon, Alex Holland, Richard G.A. Wills, 2021. An overview and prospective on Al and Al-ion battery technologies. Journal of Power Resources.

Gu, X. et al., 2016. Multifunctional Nitrogen-Doped Loofah Sponge Carbon Blocking Layer for High-Performance Rechargeable Lithium Batteries. ACS Appl. Mater. Interfaces, 8(25), pp. 15991-16001.

Huang, L.-M. & Chen, C.-H., 2018. Aluminum-Ion Battery. United States of America, Patent No. 20180219257.

Jasso, K., Kazda, T. & Cudek, P., 2017. Using Natural Sorbent Luffa Cylindrica as a Conductive Component for Positive Electrodes of Lithium-Sulfur Batteries. ECS Transactions, 81(1).

Jian, Y. et al., 2023. The giant flexoelectric effect in a luffa plant-based sponge for green devices and energy harvesters. Proceedings of the National Academy of Sciences, 120(40).

Leisegang, T. et al., 2019. The Aluminum-Ion attery: A Sustainable and Seminal Concept?. Front Chem, 7(268).

Levy, N. & Ein-Eli, Y., 2020. Aluminum-ion battery technology: a rising star or a devastating fall?. J Solid State Electrochem, Volume 24, pp. 2067-2071.

Li, C., Zhang, X. & He, W., 2018. Design and modification of cathode materials for high energy density aluminum-ion batteries: a review. J Mater Sci: Mater Electron, Volume 29, pp. 14353-14370.

Luan, P. et al., 2022. Compressible Ionized Natural 3D Interconnected Loofah Membrane for Salinity Gradient Power Generation. small, 18(2).

Miguel, A. et al., 2020. Tough Polymer Gel Electrolytes for Aluminum Secondary Batteries Based on Urea: AlCl3, Prepared by a New Solvent-Free and Scalable Procedure. Polymers, 12(6).

Miller, Y., Tzidon, D. & Yadgar, A., 2021. United States of America, Patent No. 20210075078.

Mori, R., 2020. Recent Developments for Aluminum-Air Batteries. Electrochemical Energy Reviews, Volume 3, pp. 344-369.

Mukherjee, R. & Koratkar, N. A., 2017. Rechargeable Aluminum Ion Battery. United States of America, U.S. Pat. No. 9,819,220 B2.

Mukherjee, R. et al., 2021. Aqueous aluminum ion batteries, hybrid battery-capacitors, compositions of said batteries and battery-capacitors, and associated methods of manufacture and use. United States of America, U.S. Pat. No. 10,978,734 B2.

Niksa, M. J., Niksa, A. J. & Noscal, J. M., 1990. Primary aluminum-air battery. United States of America, U.S. Pat. No. 492,5744.

Pan, W. et al., 2022. Non-aqueous Al-ion batteries: cathode materials and corresponding underlying ion storage mechanisms. Rare Met., Volume 41, pp. 762-774.

Sasaki, K., 2015. United States of America, Patent No. 20150009365.

Song, S. et al., 2019. Loofah sponge as a high-loading 3D carbon matrix for lithium-sulfur batteries. Materials Letters, Volume 247, pp. 86-89.

Stoddart, J., Kim, D., Choi, J. & Yoo, D.-J., 2021. Rechargeable Aluminum Organic Batteries. United States of America, Patent No. 2020242452.

Su, Y.-S.et al., 2020. Aluminum secondary battery having a high-capacity and high-rate capable cathode and manufacturing method. United States of America, Patnet No. 20180254512.

Wang, D.-Y.et al., 2017. Advanced rechargeable aluminium ion battery with a high-quality natural graphite cathode. Nature Communications, 8(14283).

Wang, D.-Y.et al., 2017. Advanced Rechargeable Aluminum Ion battery with a High-Quality Natural Graphite Cathode. Nature Communications, Volume 8, p. 14283.

Wang, Y. et al., 2023. Solid-state Al-air battery with an ethanol gel electrolyte. Green Energy & Environment, 8(4), pp. 1117-1127.

Yang, J. et al., 2016. A free-standing sulfur-doped microporous carbon interlayer derived from luffa sponge for high performance lithium-sulfur batteries. J. Mater. Chem. A, 4(37), pp. 14324-14333.

Yuan, D. et al., 2020. Emerging rechargeable aqueous aluminum ion battery: Status, challenges, and outlooks. Nano Materials Science, Volume 2, pp. 243-263.

Zaromb, S., 1962. The use and behavior of aluminum anodes in alkaline primary batteries. Journal of The Electrochemical Society, 109(12), pp. 1125-1130.

### FIELD OF INVENTION

The present invention generally relates to electricity generation, and more particularly to a method and apparatus for electrical energy storage using rechargeable aluminum-ion electrochemical cells.

### PRIOR ART

An aluminum-ion battery is a rechargeable battery in which aluminum ions serve as charge carriers. Aluminum-ion batteries consist of electrodes emersed in an electrolyte. The obvious material for the anode is aluminum, an alloy of aluminum, or a compound of aluminum. Common materials for the cathode (Pan, et al., 2022) include: carbon-based materials such as graphite, amorphous carbons, porous carbons (Li, et al., 2018). Common materials for the electrolyte include CO(NH₂)₂ or carbamide (also called urea), sea-salt, and acidic room temperature non-aqueous ionic liquids (IL). The ionic liquid is made of aluminum chloride (AlCl₃) and 1-ethyl-3-methylimidazolium chloride [EmIm]Cl (Miguel, et al., 2020). The use of the ionic liquid as an electrolyte prevents passivation.

Aluminum-ion batteries are promising alternatives to the lithium-ion batteries commonly used in portable electronics, electric vehicles, and stationary energy for homes, commercial buildings, and grid-scale applications. Advantages of aluminum-ion batteries include the relatively low cost, energy density, safety, and long cycle life (Leisegang, et al., 2019).

Recent investigations on aluminum-ion batteries have been conducted by:
(Wang, et al., 2017) who presented an advanced rechargeable aluminum-ion battery with a high-quality natural graphite cathode.
(Das, et al., 2017) who detailed developments and challenges faced by aluminum-ion batteries. The authors focus on the electrode materials, innovative perspectives, and future research efforts on rechargeable aluminum-ion batteries.
(Gan, et al., 2019) who designed a high-performance rechargeable aluminum battery using a graphite cathode and AlCl₃/Et₃NHCl ionic liquid electrolyte.
(Levy & Ein-Eli, 2020) who discussed the potential of aluminum-ion batteries as a cost-effective energy storage technology for renewable energy sources.
(Craig, et al., 2020) who reviewed current progress in non-aqueous aluminum batteries. The authors conclude that graphite-based positive electrodes, especially cheap and abundant graphite flakes, offer the best overall performance because of the stability and high discharge potential.
(Elia, et al., 2021) who reviewed developments in different classes of aluminum-centered batteries. The focus was on “aluminum electrolyte chemistry based on chloroaluminate melts, deep eutectic solvents, polymers, and chlorine-free formulations.”
(Yuan, et al., 2020) which describes the status, challenges, emerging, and outlooks of emerging rechargeable aqueous aluminum-ion battery.

Learned papers on the use of luffa sponge in batteries have been published by:
(Gu, et al., 2016) who developed multifunctional nitrogen-doped luffa sponge carbon blocking layer for high-performance rechargeable lithium batteries.
(Jian, et al., 2023) who reported giant flexoelectric effect in a luffa plant-based sponge for green devices and energy harvesters.
(Song, et al., 2019) who proposed luffa sponge as a high-loading 3D carbon matrix for lithium-sulfur batteries.
(Yang, et al., 2016) who described a free-standing sulfur-doped microporous carbon interlayer derived from luffa sponge for high performance lithium-sulfur batteries.
(Cui, et al., 2018) who developed porous carbon with dihydrogen phosphate groups as sulfur host for high performance lithium sulfur batteries.
(Luan, et al., 2022) who reported compressible ionized natural 3D interconnected luffa membrane for salinity gradient power generation.
(Jasso, et al., 2017) who used natural sorbent luffa cylindrica as a conductive component for positive electrodes of lithium-sulfur batteries.

Patents which taught implementations of the aluminum-ion batteries include:
(Archer, et al., 2014) which teaches an aluminum ion battery using an aluminum anode, a vanadium oxide material cathode, and an ionic liquid electrolyte. The vanadium oxide material cathode comprises a monocrystalline orthorhombic vanadium oxide material.
(Mukherjee & Koratkar, 2017) which describes a rechargeable battery using a solution of an aluminum salt as an electrolyte.
(Huang & Chen, 2018) which describes an aluminum-ion battery using an electrolyte comprising of an aluminum halide, a solvent and a compound made from alkyl or fluoroalkyl group.
(Gao & Chen, 2018) which discloses a method of preparing a graphene anode material by coating a graphene oxide solution on a substrate, drying, removing the substrate, performing reduction, and obtaining a graphene film with ultra-high conductivity.
(Mukherjee, et al., 2021) which describes an aqueous aluminum ion battery with improved charge storage capacity.
(Stoddart, et al., 2021) which discloses rechargeable aluminum batteries using cathodic phenanthrenequinone unit and a graphite flake.
(Azimi & Ng, 2023) which describes aluminum-ion battery technology with an electrolyte consisting of an aluminum trichloride (Al—Cl3)/trimethylamine hydrochloride ionic liquid, aluminum metal as the anode material, and a compatible cathode active material.
(Su, et al., 2020) which describes an aluminum-ion battery with a cathode comprising of a layer of recompressed exfoliated graphite or carbon material that is oriented in such a manner that the layer has a graphite edge plane in direct contact with the electrolyte and facing the separator.
(Caban-Acevado & Yushin, 2023) which describes rechargeable batteries with alkali metal ion cathodes, aluminum metal-based anodes and displacement electrolyte.

### BACKGROUND OF THE INVENTION

Aluminum-ion batteries are emerging as better alternatives to lithium-ion batteries, the leading choice for wireless devices, computers, electric mobility, and small-scale to grid-scale stationary energy storage applications. The advantages of aluminum-ion batteries over lithium-ion batteries include: cost-effectiveness of aluminum because of its abundance in the Earth's crust; safety because aluminum-ion batteries are less prone to thermal runaway and fire hazards; significantly higher theoretical energy density, 1060 Wh/kg versus 406 Wh/kg theoretical limit for lithium-ion batteries; high recyclability of aluminum; longevity due to the large number of charging and discharging cycles of aluminum-ion batteries.

This invention uses the advantages inherent in the electrochemistry of aluminum-ion batteries to teach the construction of an ultra-low-cost all-solid-state rechargeable battery. The electrodes maximize electrochemical reaction surfaces. The cells are easy to build. The cell components are affordable and widely available materials.

### SUMMARY OF THE INVENTION

According to the present invention there is provided a method of storing electrical energy using a membrane-free electrochemical cell comprising a cylindrical exterior container, a coiled anodic aluminum wire, carbonized luffa sponge, and a solid electrolyte consisting of a compound mixture of urea, sea-salt, and sodium silicate.

An advantage of the present invention is the provision of a method and apparatus for converting electricity into chemical energy stored in an aluminum-ion cell.

Still another advantage of the present invention is the provision of a method and apparatus for electricity storage which utilizes a solid electrolyte.

Still another advantage of the present invention is the provision of a method and apparatus for electricity storage which utilizes a coiled anodic aluminum wire.

Still another advantage of the present invention is the provision of a method and apparatus for electricity storage which utilizes carbonized luffa sponge.

Still another advantage of the present invention is the provision of a method and apparatus for electricity storage which is membrane-free.

Still other advantages of the invention will become apparent to those skilled in the art upon reading and understanding the following detailed description, accompanying drawings and appended claims.

### BRIEF DESCRIPTION OF DRAWINGS

The invention may take physical form in certain parts and arrangements of parts, a preferred embodiment and method of which will be described in detail in this specification and illustrated in the accompanying drawings which form a part hereof, and wherein:

FIG. 1 is an illustration of the isometric view of the Aluminum-Ion Cell;

FIG. 2 is an illustration of the horizontal cross-section of the Aluminum-Ion Cell;

FIG. 3 is an illustration of the vertical cross-section of the Aluminum-Ion Cell;

FIG. 4 is an image of the hollowed-out luffa sponge;

FIG. 5 is an image of the coiled aluminum anode;

FIG. 6 is an illustration of the steps involved in the construction of the aluminum-ion cell with the coiled aluminum anode, the carbonized luffa sponge, and the solid electrolyte.

### DETAILED DESCRIPTION OF THE INVENTION

It should be appreciated that while a preferred embodiment of the present invention will be described with reference to aluminum-ion electrochemical cell, other metal-ion electrochemical cells are also suitable for use in connection with the present invention. These include zinc-ion, iron-ion, magnesium-ion, lithium-ion, calcium-ion, sodium-ion, potassium-ion, and tin-ion electrochemical cells.

In accordance with a preferred embodiment, the present invention teaches the storage of electricity using an electrochemical cell comprising a) a cylindrical exterior container; b) a coiled axially placed anodic wire; c) a carbonized luffa sponge; and d) an electrolyte based on a mixture of urea, sea-salt, and sodium silicate.

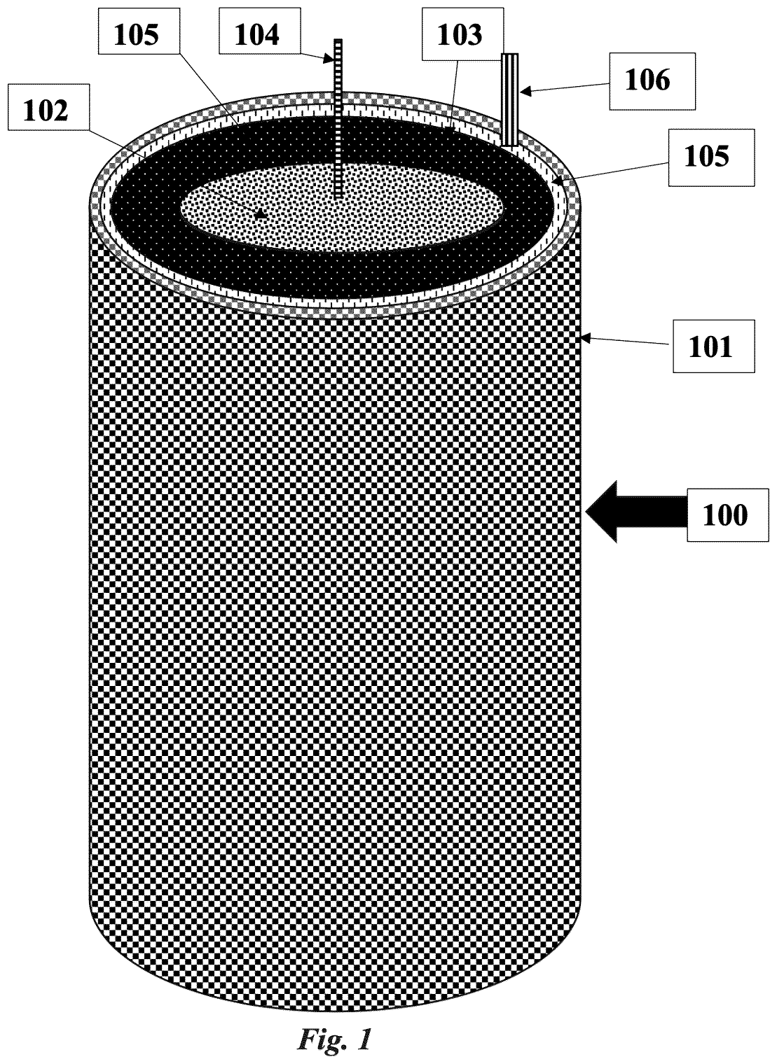

Referring now to the drawings wherein the showings are for the purposes of illustrating a preferred embodiment of the invention only and not for purposes of limiting same. FIG. 1 is the illustration of the isometric view of aluminum-ion electrochemical cell 100 with exterior container 101. Coiled anodic aluminum wire 104 is placed at the axial center of exterior container 101. Cathode 103 consists of hollowed-out carbonized luffa sponge placed inside exterior container 101. Solid electrolyte 102 occupies the entirety of the exterior container except the spaces taken up by anodic coil 104, and cathode 103.

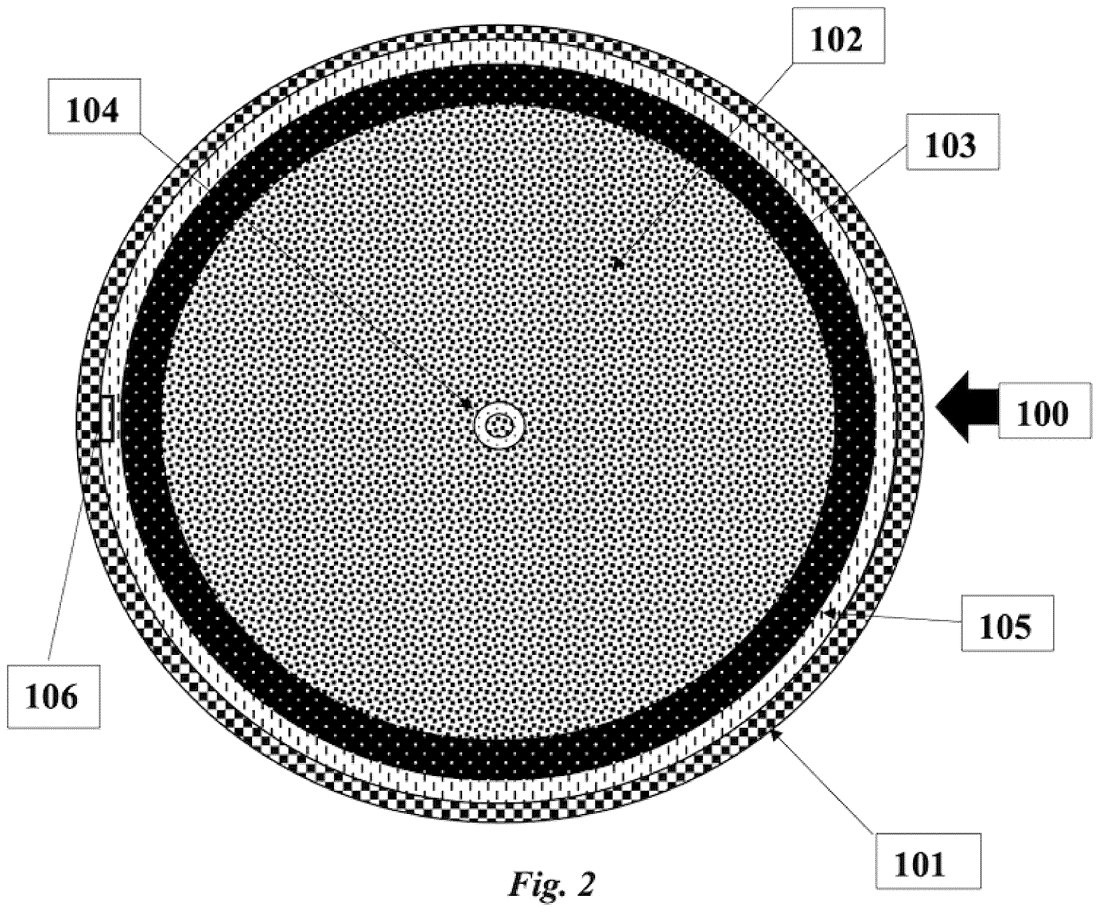

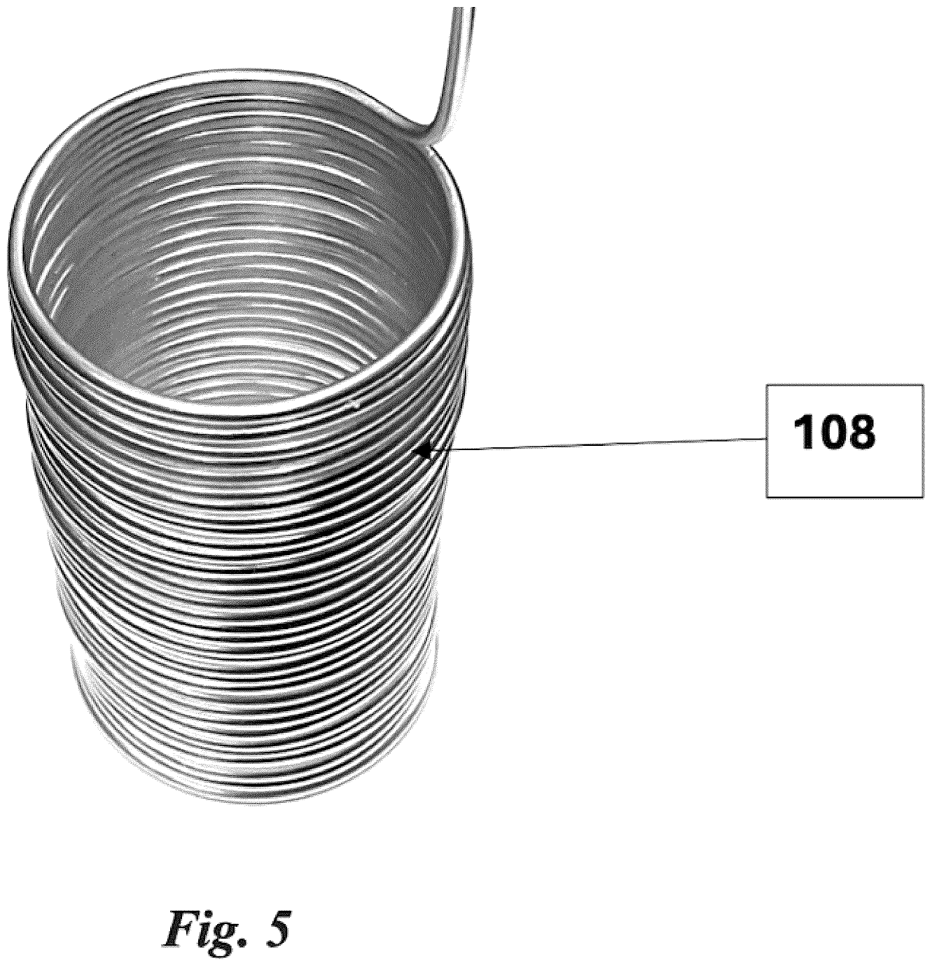

Referring now to FIG. 2 and FIG. 5:
1. Exterior Container 101. According to this invention, exterior container 101 consists of polycarbonate rigid tube.
2. Electrolyte 102. According to this invention, electrolyte 102 is formulated by mixing x parts by volume of powdery urea (NH₂)₂CO with y parts by volume of sea-salt, with z parts by volume of sodium silicate (water glass). The mixture is stirred until a uniformly smooth gel is achieved. Freshly mixed electrolyte 102, with special urea/sea-salt/water glass mix ratios, is characterized by rapid solidification. Therefore, it must be injected quickly into the cavity of electrochemical cell 100 prior to solidification.
3. Cathode 103. According to the preferred embodiment of this patent, cathode 103 consists of carbonized hollowed-out luffa sponge. Carbonization is achieved by soaking the luffa sponge in a carbon ink formed by a compound mixture of graphite powder and Polyvinyl Acetate (PVA), a vinyl polymer.
4. Anode 104. According to this invention, anode 104 is cylindrical coil 108, made by spirally winding a single aluminum wire. The diameter of the single wire should not exceed 3 mm. The purity of the aluminum wire must be 99% at the minimum.

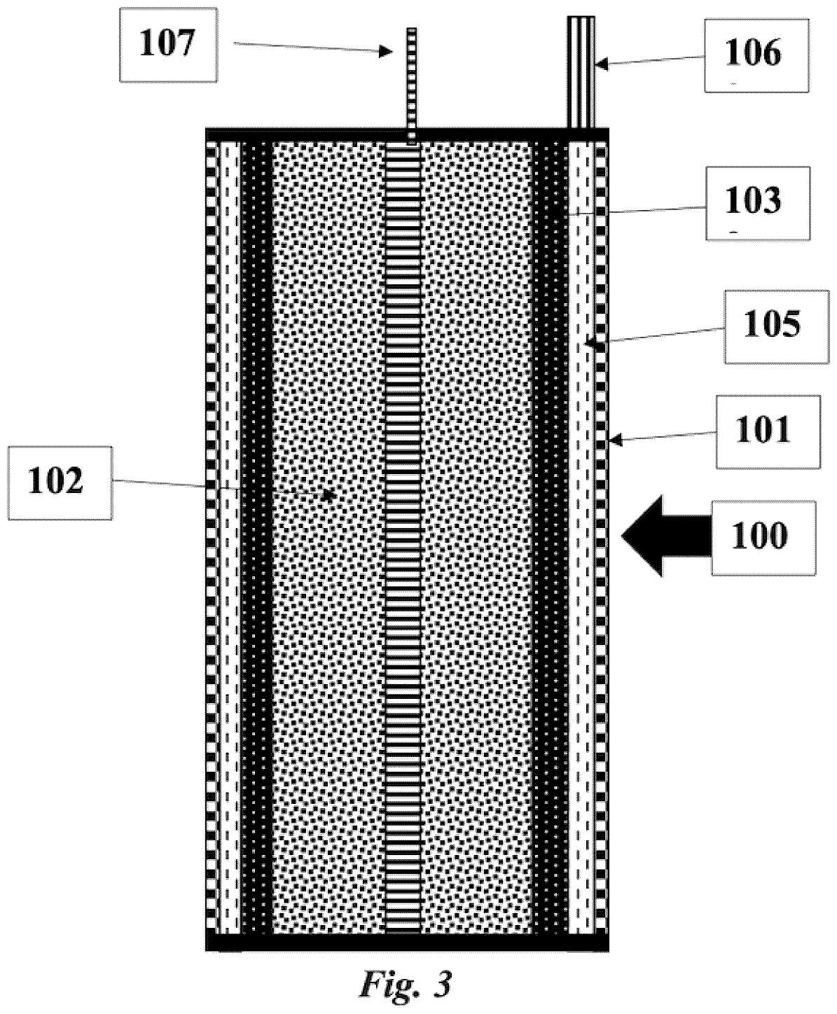

Referring now to FIG. 3:
1. Current Collector 105. According to the preferred embodiment of this patent, current collector 105 consists of a conductive metal tube, made preferably by folding plain copper sheet, copper foil, or mesh of copper into a cylindrical shape. Current collector 105 is sandwiched between exterior container 101 and cathode 103.
2. Positive Terminal 106: According to the preferred embodiment of this patent, positive terminal 106, is a thin nickel strip (thickness 0.15 mm, width 8 mm) attached to current collector 105.
3. Negative Terminal 107: According to the preferred embodiment of this patent, negative terminal 107, is the protruding end of coiled aluminum wire anode 102.

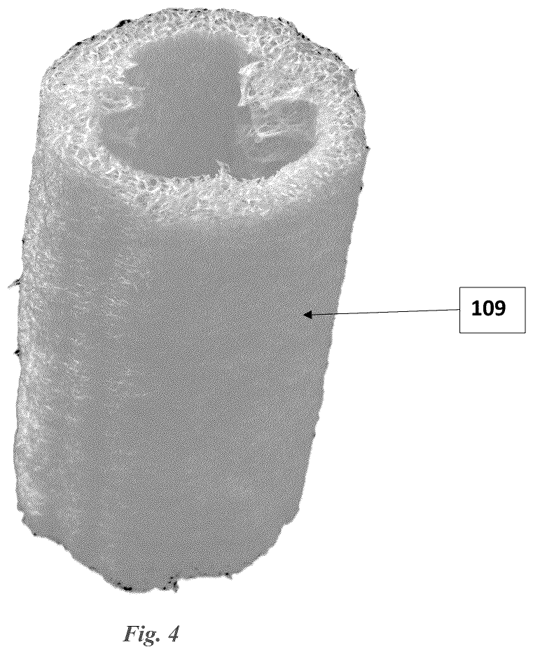

Referring now to FIG. 4: Luffa Sponge 109. According to the preferred embodiment of this patent, luffa sponge 109, is hallowed out organic Thaumatococcus Daniellii. The carbonized luffa sponge 109 can be sliced into strips to fit the internal dimensions of exterior container 101.

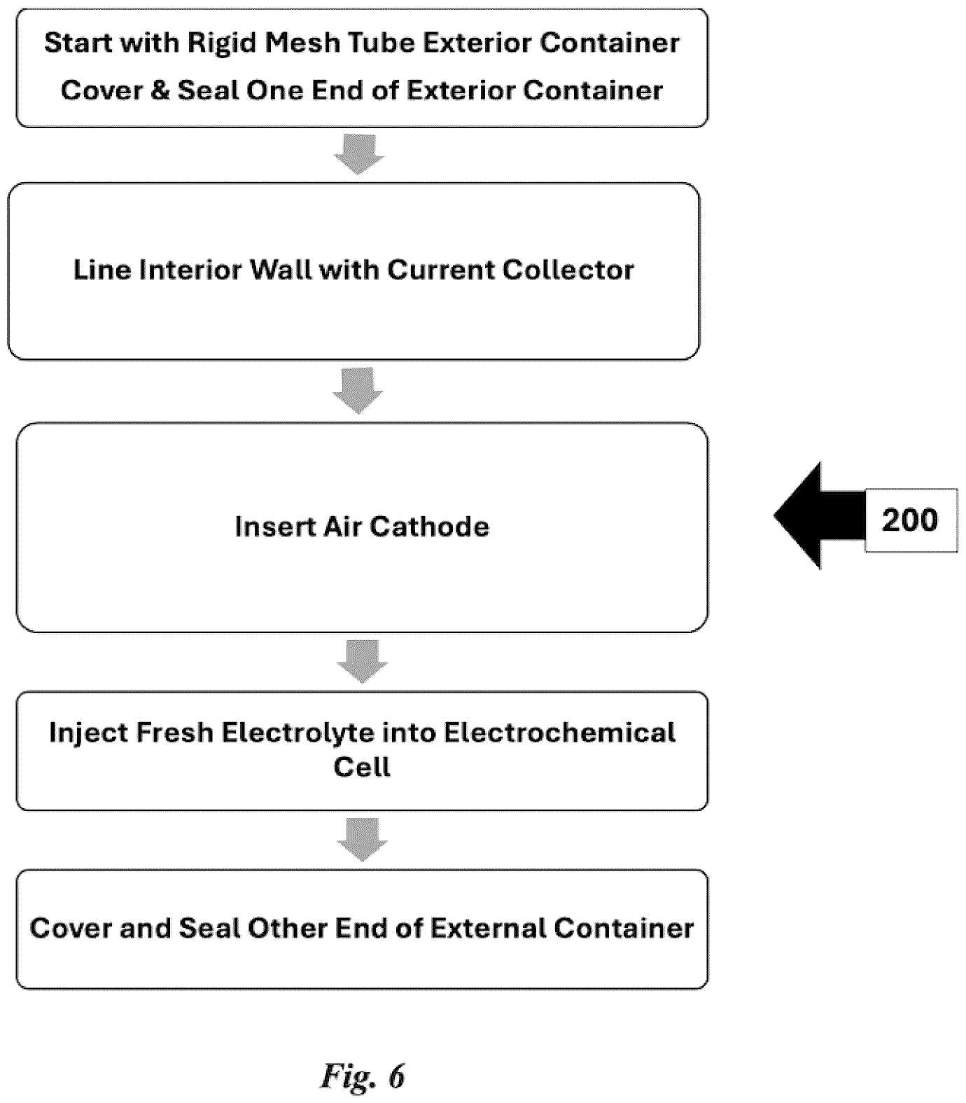

Referring now to FIG. 6: The steps 200 involved in the construction of aluminum-ion cell 100 are:
1. Start with Exterior Container 101
2. Cover & Seal One End of Exterior Container 101
3. Line Interior Wall with Current Collector 105
4. Insert Air Cathode 103
5. Inject Fresh Electrolyte 102 into Electrochemical Cell 100
6. Cover and Seal Other End of External Container 101

### EXAMPLE

To establish the characteristics of the aluminum-ion electrochemical cell, according to the invention disclosed herein, a charge and discharge test was conducted on a cell of distinct dimensions, anodic coil, and carbonized luffa sponge. The electrolyte mixture consists of 5 ml of urea, 5 ml of sea-salt, and 240 ml of sodium silicate.
Diameter of Exterior Container: 50 mm
Length of Exterior Container: 150 mm
Anode: Cylindrical coil (Diameter: 12 mm, Height: 70 mm) made by spirally winding 2 mm (Gauge 12) aluminum wire.
Cathode: Carbonized strips of hollowed-out luffa sponge
Discharge current: 10 mA
Discharge test duration: 664 minutes
Current Capacity: 111 mAh
Energy Produced: 108 mWh
Open Circuit Voltage: 1.5V
Average Operating Voltage: 0.97V

The present invention has been described with reference to a preferred embodiment. Obviously, modifications and alterations will occur to others upon a reading and understanding of this specification. It is intended that all such modifications and alterations be included insofar as they come within the scope of the appended claims or the equivalents thereof.

1. According to the present invention there is provided a method of storing electrical energy using an electrochemical cell comprising a cylindrical exterior container, coiled anodic wire, organic porous material, and electrolyte based on a compound mixture of urea, sea-salt, and sodium silicate.

2. A method according to claim 1, wherein the cathode consists of carbonized organic porous material, Thaumatococcus Daniellii, commonly referred to as luffa sponge.

3. A method according to claim 2, wherein the luffa sponge is hollowed out.

4. A method according to claim 3, wherein the luffa is cut into strips.

5. A method according to claim 2, wherein the luffa sponge is carbonized by soaking in carbon ink consisting of mixture of graphite powder and Polyvinyl Acetate (PVA).

6. A method according to claim 1, wherein the anode consists of cylindrical aluminum coil obtained by spiral wrapping an aluminum wire.

7. A method according to claim 1, wherein the electrolyte is solid, consisting of a compound mixture of urea, sea-salt, and sodium silicate.

8. A method according to claim 7, wherein freshly made electrolyte, in fluid state, is injected into the cell chamber.

9. A method according to claim 1, wherein the electrochemical cell is membrane-free.
